(19) United States
(12) Patent Application Publication
(10) Pub. No.: US 2021/0029980 A1
(43) Pub. Date: Feb. 4, 2021

(54) Alligator Fishing Accessories

(71) Applicant: William W. Gray, Vicksburg, MS (US)

(72) Inventor: William W. Gray, Vicksburg, MS (US)

(21) Appl. No.: 16/930,477

(22) Filed: Jul. 16, 2020

Related U.S. Application Data
(60) Provisional application No. 62/880,129, filed on Jul. 30, 2019.

(51) Int. Cl. A01K 83/04; A01K 91/00; A01K 93/00

(52) U.S. Cl. CPC A01K 83/04; A01K 93/00; A01K 91/00

(57) ABSTRACT

The present disclosure provides a snag hook comprising a hook comprising at least one hook bend and barb; and a body, wherein the body is coated with a plurality of coating materials, wherein a first coating material is an opaque base powder coat material and a second coating material is a clear powder coat material mixed with a luminescent material or agent. In an alternate embodiment, the present disclosure provides a quick release snare comprising a handle; and a cable portion, wherein the cable portion further comprises a loop generating element.

### CROSS REFERENCE TO RELATED APPLICATIONS

This application claims the benefit of, and priority to, pending U.S. Provisional Patent Application No. 62/880,129 filed Jul. 30, 2019.

### FIELD OF THE DISCLOSURE

The present disclosure pertains to the field of alligator fishing or hunting for either commercial or recreational/sport purposes. More specifically, the present disclosure pertains a luminous weighted snag/snatch hook and a quick release snare.

### BACKGROUND

Alligator fishing (or hunting) is a popular past time in many areas, especially in the Southeastern United States. Generally, alligator fishing is either for commercial purposes or for sport. The method of fishing is often dependent on the purpose, for example, commercial fishing often involves a bait and hook method wherein the alligator is shot and killed before harvest. Sport fishing may involve a casted hook and line wherein a large hook is used to snag the alligator and the alligator is eventually subdued using rod and reel. If a sport fisherman is fishing at night, it would be desirous to have a visual indicator of where the hook has been cast to determine whether the hook will be in position to snag the alligator. Likewise, especially in sport fishing where the number and size of legal alligators may be tightly controlled, it is desirable to have a method to secure the alligator after it is subdued to determine whether the alligator should be harvested or released. It is also desirable to have a method of quickly and safely releasing the alligator should it be determined that it will not be harvested while securely retaining the alligator while that decision is made. Additionally, restraint by a rope or a cable is often required by law prior to harvesting. The present disclosure provides both a luminous weighted snag/snatch hook and a quick release snare.

### BRIEF DESCRIPTION OF THE DRAWINGS

To further illustrate the advantages and features of the present disclosure, a more particular description of the invention will be rendered by reference to specific embodiments thereof which are illustrated in the appended drawings. It is appreciated that these drawings are not to be considered limiting in scope. The invention will be described and explained with additional specificity and detail through the use of the accompanying drawings in which:

FIG. 1 shows a side view of one embodiment of a luminous weighted snag/snatch hook provided herein.

FIG. 2 shows a top view of one embodiment of a luminous weighted snag/snatch hook provided herein.

FIG. 3 shows a cross-sectional view of an alternate view of a luminous weighted snag/snatch hook provided herein

FIG. 4 shows one embodiment of the snare provided herein.

FIG. 5 shows an alternate view of one embodiment of the snare of FIG. 4.

FIG. 6 shows an alternate view of one embodiment of the snare of FIG. 4.

FIG. 7 shows an alternate view of one embodiment of the snare of FIG. 4.

FIG. 8 shows an alternate view of one embodiment of the snare of FIG. 4.

FIG. 9 shows an alternate view of one embodiment of the snare of FIG. 4.

### DETAILED DESCRIPTION

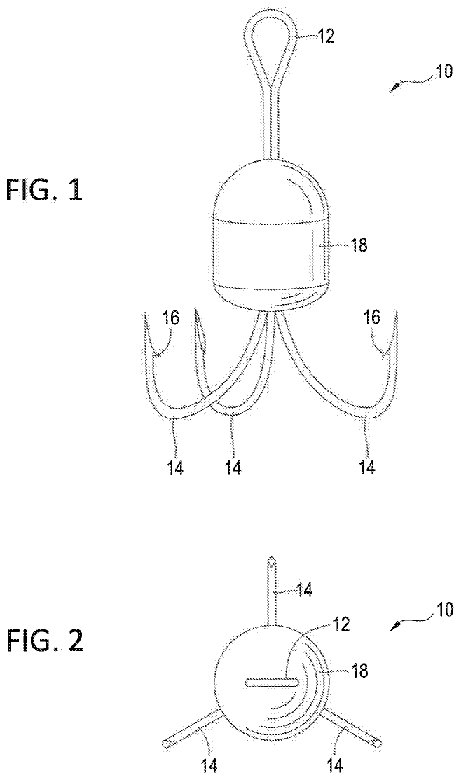

Now referring to FIGS. 1-3, the present disclosure provides a luminous weighted snag/snatch hook 10 and method of making the same. In one embodiment, a luminous weighted snag/snatch hook 10 includes an eyelet 12, hook bends 14, barbs 16 and a body 18.

Fishing hooks are sized on a scale wherein a 1/0 hook is considered the middle of the scale. Smaller hooks are given a size designation of #1, #2, etc. while larger hooks are given a designation of #2/0, #3/0, etc. The luminous weighted snag/snatch hook 10 of the present disclosure needs to be of sufficient size and strength to withstand the forces encountered when an alligator has been snagged. Accordingly, as would be recognized by one of skill in the art, a hook size of #8/0, #10/0 or #12/0 is preferred, but other sizes may be appropriate in certain conditions or locations. Additionally, a treble hook with three (3) separate hooks is preferred as well to increase the odds of snagging an alligator. Each independent hook also has a hook bend 14 and a barb 16. The luminous weighted snag/snatch hook 10 also includes a body 18 positioned between the hook bends 14 and the eyelet 12.

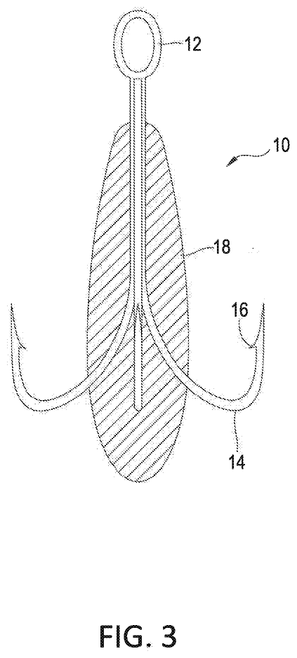

The body 18 may be made out of any suitable material to provide both weight to the luminous weighted snag/snatch hook 10 (which aids in casting among other things) and a bonding surface 18a for the coating agents 18b. For example, as shown in FIGS. 1-2, the body 18 may be manufactured from lead that is melted and formed into the generally bullet shape of the body 18. Alternatively, as shown in FIG. 3, the body 18 may be more of a teardrop shape. The teardrop shaped body 18 makes casting (or throwing) the luminous weighted snag/snatch hook 10 easier and allows it to be quitter when it enters the water, reducing the chance of scaring an alligator. In one preferred embodiment, the coating agents 18b when bonded to the body 18 are luminescent and glow in dark environments.

Also provided by the present disclosure is a method of making the luminous weighted snag/snatch hook 10. The preferred embodiment is described below, however, as would be recognized by one of ordinary skill in the art, the claimed method should not be limited to the description below.

First, a treble hook is placed into a mold in which molten lead is poured around the treble hook's shank. As the molten lead solidifies, the body 18 is formed. The mold is then inverted and opened releasing the weighted hook 10 from the mold wherein the hook bends 14 are in contact with a cool, preferably wetted surface to prevent heat from the hot lead conducting past the hook bend 14 to the barb 16. The luminous weighted snag/snatch hook 10 is then immersed, while the lead is still hot, in one or more coating agents 18b. In one embodiment, there is a series of coating agents 18b used which are applied sequentially. In this embodiment, the first coating agent 18b is a white or other opaque color powder coat material in a fluid bath (optionally the color of this first coating agent is similar or identical to the desired luminescent color of the finished body of the hook) to provide a base coat. The hot lead body 18 will melt and liquify the white or other color powder coat material which will then adhere to the lead body 18. Then, immediately after extracting from the white or other color powder coat material, the weighted hook 10 is immersed in a second fluid bath containing a second clear colored powder coating material mixed with a light emitting luminescent material or agent. Again, there is sufficient residual heat from the now solidified, but still hot, lead to melt or liquify second coating agent adhering it to the first coating agent. The luminous coated hook 10 is then extracted from fluid bath and allowed to cool and cure before use.

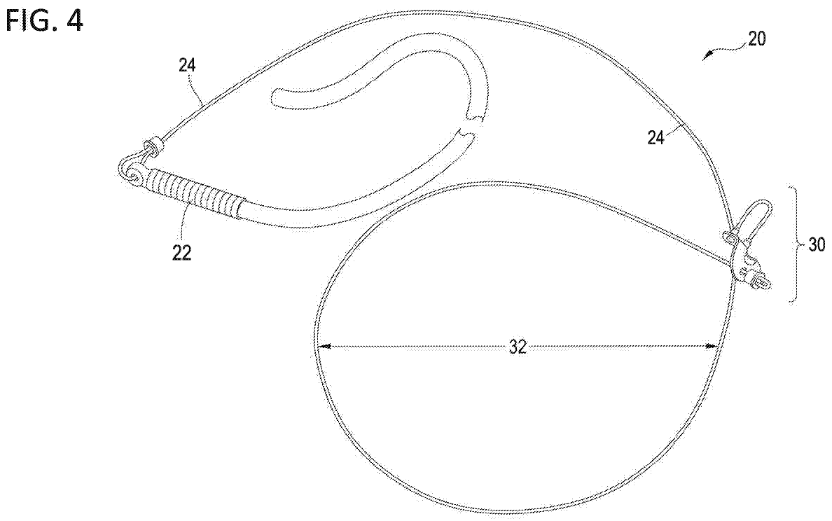

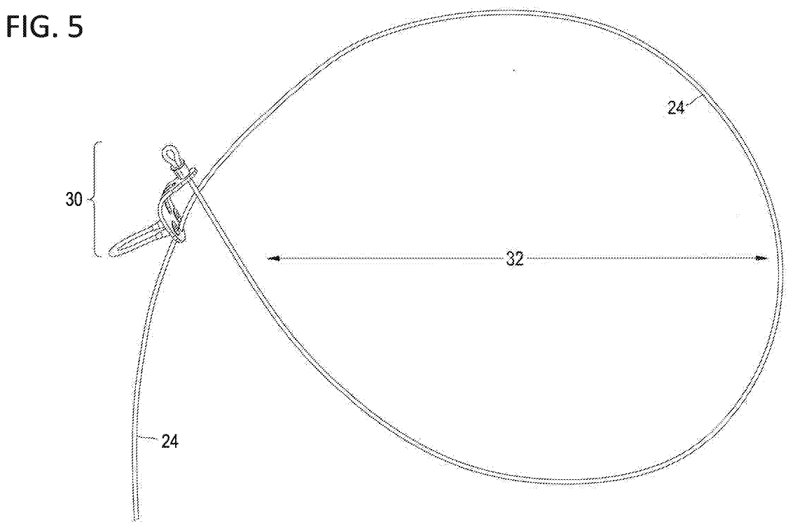

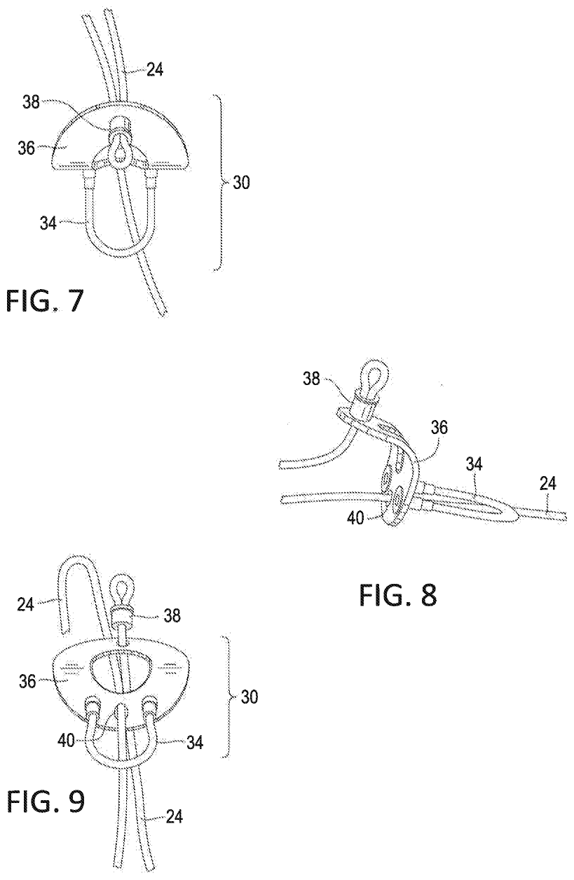

Now referring to FIGS. 3-8, also provided in the present disclosure is a quick release snare 20 including a handle 22 connected to a cable portion 24. The handle 22 should be constructed from a material that is comfortable to grasp and manipulate while using the snare 20. In the embodiment shown herein, the handle 22 comprises rope (such as single braided polyester or nylon) however, other suitable materials should be considered within the scope of this disclosure. Additionally, the handle 22 should be of sufficient length to allow the user to handle and manipulate the alligator, which is often fighting or attempting to escape. For example, it is desirable to have a handle 22 of approximately 20 feet in length or longer. Also, the handle 22 may optionally comprise a buoy (not shown) on the end opposite its connection with the cable portion 24. If during subduing the alligator, the alligator pulls the handle 22 from the user's hands, the buoy (not shown) will remain on the surface of the water and allow the alligator to be located. The handle 22 is connected to the cable portion 24 by methods known in the art. The material for the cable portion 24 should be selected from those of suitable strength to withstand the forces encountered during use. For example, in one embodiment, the cable portion 24 comprises ⅛^{th} inch diameter stainless steel cable.

At the end of the cable portion 24, the snare 20 includes a loop generating element 30. As will be described below, the loop generating element 30 creates a loop 32 that may be expanded or collapsed during the use of the snare 10 as shown in FIGS. 3-5. For example, it would generally be desirable to expand the loop 32 while both placing the snare 10 over the alligator's head and while removing it from the alligator's head but collapse the loop 32 to secure it around the alligator's head.

The loop generating element 30 includes a fixed loop 34, a washer 36 and a securement means 38. The washer 36 is modified in the following manner. First, a series of additional openings are made within the washer 36 to allow the cable portion 24 to pass through the washer 36 and to allow the securement of the cable portion 24 to the washer 36 via the securement means 38. These openings may be made using a drill bit or other suitable means. There may be more than one opening of different size. For example, the fixed loop 34 is secured to the washer 36 via opposing openings of identical size. Additionally, the securement means 38 securing the cable portion 24 to the washer may or may not use a different sized opening. Finally, the cable portion 24 passes through yet another opening 40 that may or may not be the same size as other openings. In one embodiment, the opening through which the cable portion 24 passes (and through which the cable portion 24 forms the loop 32) is of a different size than the other openings on the washer 36. In one preferred embodiment, this opening is smaller than the other openings as will be described below.

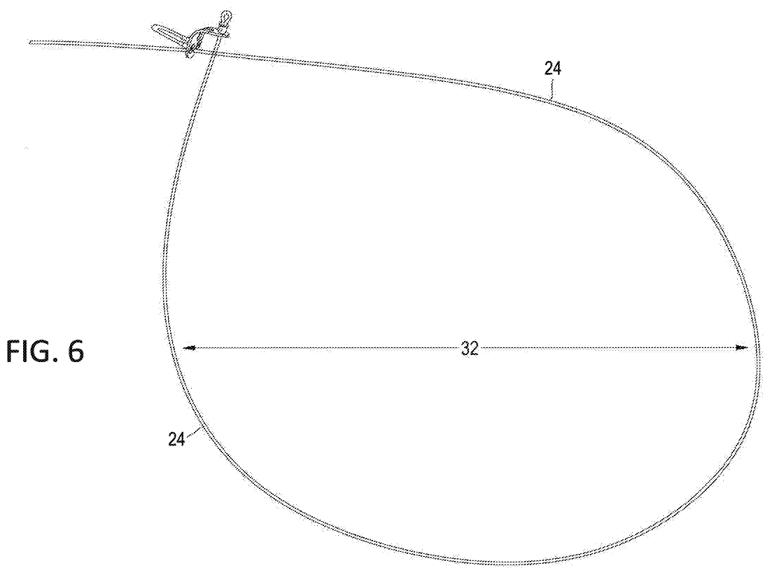

As will be seen in the attached figures such as FIGS. 6-8, the washer 36 is bent from its normal flat configuration. In one embodiment, the washer 36 is bent such that it is at a greater than 90-degree angle but less than a 110-degree interior angle. Preferably the washer 36 is bent at approximately a 100-degree angle. The opening 40 through which the cable portion 24 passes is formed by passing a drill bit (or other suitable boring means) form the outside edge of the washer 36 such that the as the drill bit passes through the washer 36 the drill bit almost touches the opposite interior edge of the washer 36. This axis of passage through the washer 36 creates an opening 40 having an open arc of approximately 125 degrees.

The fixed loop 34 is secured to the washer 36 by bending a portion of cable and securing it to the washer by any suitable means known to those of ordinary skill in the art. For example, the fixed loop 34 may be secured by welding, using crimps and/or pop rivets.

The angles created by bending the washer 36 and the passage of the drill bit (or other suitable boring means) as described above to create opening 40 are critical to the operation of the snare 20. When not under tension, the cable portion 24 may pass freely through the opening 40. However, when under tension, the cable portion 24 is held via friction such that it cannot pass through the opening 40. Thus, the loop 32 may be expanded or collapsed during use. Once the loop 32 is collapsed around an alligator, friction forces will hold the cable portion 24 in place thus maintaining the desired loop 32 size. If it desired to expand the loop 32 and thereby release the alligator, a generally upward force applied with the fixed loop 34 will change the angle through which the cable portion 24 passes through the opening 40 (and thereby the washer 36) reducing the friction between the washer 36 and the cable portion 24 allowing the cable portion 24 to pass through the opening 40.

Although particular embodiments of the present disclosure have been described, it is not intended that such references be construed as limitations upon the scope of this disclosure except as set forth in the claims.

We claim:

1. A snag hook comprising:
a. a hook comprising at least one hook bend and barb; and
b. a body, wherein the body is coated with a plurality of coating materials, wherein a first coating material is a base powder coat material and a second coating material is a clear powder coat material mixed with a luminescent material or agent.

2. The snag hook of claim 1 wherein the treble hook is either a size #8/0, #10/0 or #12/0 treble hook.

3. The snag hook of claim 1 wherein the body is substantially bullet shaped.

4. The snag hook of claim 1 wherein the body is substantially tear dropped shaped.

5. The snag hook of claim 2 wherein the body is substantially bullet shaped.

6. The snag hook of claim 2 wherein the body is substantially tear dropped shaped.

7. The snag hook of claim 1 where in the body comprises lead.

8. The snag hook of claim 1 wherein the body doesn't extend past the at least one hook bend.

9. The snag hook of claim 2 wherein the body comprises lead.

10. The snag hook of claim 9 wherein the body doesn't extend past the at least one hook bend.

11. The snag hook of claim 4 wherein the body comprises lead.

12. A quick release snare comprising:
a. a handle; and
b. a cable portion, wherein the cable portion further comprises a loop generating element.

13. The quick release snare of claim 12 wherein the handle further comprises a buoy.

14. The quick release snare of claim 12 wherein the loop generating element further comprises a fixed loop of cable, a washer and a securement means.

15. The quick release snare of claim 14 wherein the washer comprises a plurality of openings in the surface thereof, wherein at least two (2) of the openings are of identical size.

16. The quick release snare of claim 14 wherein the washer is bent at an angle from between 90-degrees and 110-degrees.

17. The quick release snare of claim 16 wherein the angle is approximately 100-degrees.

18. The quick release snare of claim 13 wherein the loop generating element further comprises a fixed loop of cable, a washer and a securement means.

19. The quick release snare of claim 18 wherein the washer comprises a plurality of openings in the surface thereof, wherein at least two (2) of the openings are of identical size.

20. The quick release snare of claim 19 wherein the washer is bent at an angle from between 90-degrees and 110-degrees.
